(19) United States
(12) Patent Application Publication
(10) Pub. No.: US 2025/0060174 A1
(43) Pub. Date: Feb. 20, 2025

(54) CLIP FASTENER

(71) Applicant: VALEO SYSTEMES THERMIQUES, La Verriere (FR)

(72) Inventors: Ana-Luisa TORRES, San Luis Potosi (MX); Armando-Rafael OLMOS, San Luis Potosi (MX); Mauro-Josue CARRERA, San Luis Potosi (MX)

(73) Assignee: VALEO SYSTEMES THERMIQUES, La Verriere (FR)

(21) Appl. No.: 18/449,916

(22) Filed: Aug. 15, 2023

(51) Int. Cl. F28F 9/26; F16B 7/04

(52) U.S. Cl. CPC F28F 9/26; F16B 7/04; F28F 2275/08

(57) ABSTRACT

A clip fastener for cooperating with a counter clip fastener, having: a base portion, a pair of first members, a pair of second members, a support member, a pair of connection portions. The pair of the second members is located between the pair of the first members. The support member is located between the pair of the second members. One of the pair of the connection portions is located between and connected with the support member and one of the pair of the second members, while the other one of the pair of the connection portions is located between and connected with the support member and the other one of the pair of the second members. Each of the pair of the connection portions includes a cut located adjacent to a respective one of the pair of the second members.

### TECHNICAL FIELD

The present invention relates to a clip fastener adapted to connect two parts together, particularly to connect a heat exchanger to another part.

### BACKGROUND

Generally, a heat exchanger comprises a clip fastener adapted to connect the heat exchanger to another part, such as an air duct, stone guard, fan unit or another heat exchanger. The clip fastener comprises at least two engagement members and a support member, wherein the clip fastener is adapted to connect to a counter clip fastener provided in the other part. When the clip fastener is connected to the counter clip fastener, the at least two engagement members of the clip fastener engage with and retain the counter clip fastener, and the support member of the clip fastener supports the counter clip fastener. The clip fastener is subjected to high stress when the clip fastener is connected to the counter clip fastener. Further, the clip fastener breaks if the stress increases above a threshold value, leading to disconnection of the heat exchanger from the other part.

### SUMMARY

An objective of the present invention is to provide a clip fastener that alleviates the problems in the prior arts. To be more precise, an objective of the present invention is to reduce stress in a clip fastener when the clip fastener is connected to a counter clip fastener.

Another objective of the present invention is to prevent failure of the clip fastener when the clip fastener is connected to the counter clip fastener.

To achieve the above objectives, an embodiment of the present invention herein provides a clip fastener. A clip fastener comprising: a base portion from which two first members and two second members extend, wherein the two first members together with the two second members being adapted to engage with and retain a counter clip fastener; a support member extending from the base portion, adapted to support the counter clip fastener; and two connection portions extending from the base portion, at one end, are connected to the support member and at another end, are connected to the two second members respectively, wherein two cuts are provided in the two connection portions respectively.

In one aspect, the two second members are located between the two first members.

In another aspect, the two second members are configured to push the counter clip fastener away from the clip fastener.

In another aspect, the two first members are configured to prevent the counter clip fastener from moving away from the clip fastener.

In another aspect, height of the two first members from the base portion is higher than that of the two second members.

In another aspect, the support member is located between the two second members.

In another aspect, the support member is configured to guide the counter clip fastener.

In another aspect, the two cuts are located adjacent to the two second members respectively.

In another embodiment, the present invention herein provides an assembly. The assembly comprises: a first part comprising a clip fastener, adapted to connect to a second part comprising a counter clip fastener, wherein the clip fastener includes two first members and two second members extending from a base portion, wherein the two first members together with the two second members are adapted to engage with and retain the counter clip fastener; a support member extending from the base portion, adapted to support the counter clip fastener; and two connection portions extending from the base portion, at one end, are connected to the support member and at another end, are connected to the two second members respectively, wherein two cuts are provided in the two connection portions respectively.

In another aspect, the two second members are located between the two first members.

In another aspect, the two second members are configured to push the counter clip fastener away from the clip fastener.

In another aspect, the two first members are configured to prevent the counter clip fastener from moving away from the clip fastener.

In another aspect, height of the two first members from the base portion is higher than that of the two second members.

In another aspect, the support member is located between the two second members.

In another aspect, the support member is configured to guide the counter clip fastener.

In another aspect, the two cuts are located adjacent to the two second members respectively.

In another aspect, the counter clip fastener comprises a first portion adapted to engage with the two first members of the clip fastener.

In another aspect, the counter clip fastener comprises a second portion adapted to engage with the two second members of the clip fastener.

In another aspect, the counter clip fastener comprises an opening adapted to engage with the support member of the clip fastener.

In another aspect, the first part is a heat exchanger.

In another aspect, the second part is any one of an air duct, stone guard, fan unit or another heat exchanger.

According to the above embodiments, the clip fastener comprises the two cuts adjacent to the two second members respectively, in the two connection portions respectively. Therefore, stress in the clip fastener is reduced when the clip fastener is connected with the counter clip fastener.

Since the stress in the clip fastener is reduced, failure of the clip fastener is prevented when the clip fastener is connected with the counter clip fastener.

### BRIEF DESCRIPTION OF DRAWINGS

Other characteristics, details and advantages of the invention can be inferred from the description of the invention hereunder. A more complete appreciation of the invention and many of the attendant advantages thereof will be readily obtained, as the same becomes better understood by reference to the following description when considered in connection with the accompanying figures, wherein:

FIG. 1 illustrates a clip fastener, in accordance with an embodiment of the present invention;

FIG. 2 illustrates a counter clip fastener adapted to connect to the clip fastener of FIG. 1;

FIG. 3 illustrates an assembly of the clip fastener of FIG. 1 and the counter clip fastener of FIG. 2;

FIG. 4 illustrates a sectional view of the assembly of the clip fastener and the counter clip fastener of FIG. 3; and

FIG. 5 illustrates an assembly of a first part comprising the clip fastener of FIG. 1 and a second part comprising the counter clip fastener of FIG. 2, in accordance with another embodiment of the present invention.

### DETAILED DESCRIPTION

It must be noted that the figures disclose the invention in a detailed enough way to be implemented, the figures helping to better define the invention, if need be. The invention should however not be limited to the embodiments disclosed in the description.

In the present description, some elements or parameters may be indexed, such as a first element and a second element. In this case, unless stated otherwise, this indexation is only meant to differentiate and name elements that are similar but not identical. No idea of priority should be inferred from such indexation, as these may be switched without betraying the invention. Additionally, this indexation does not imply any order in mounting or use of the elements of the invention.

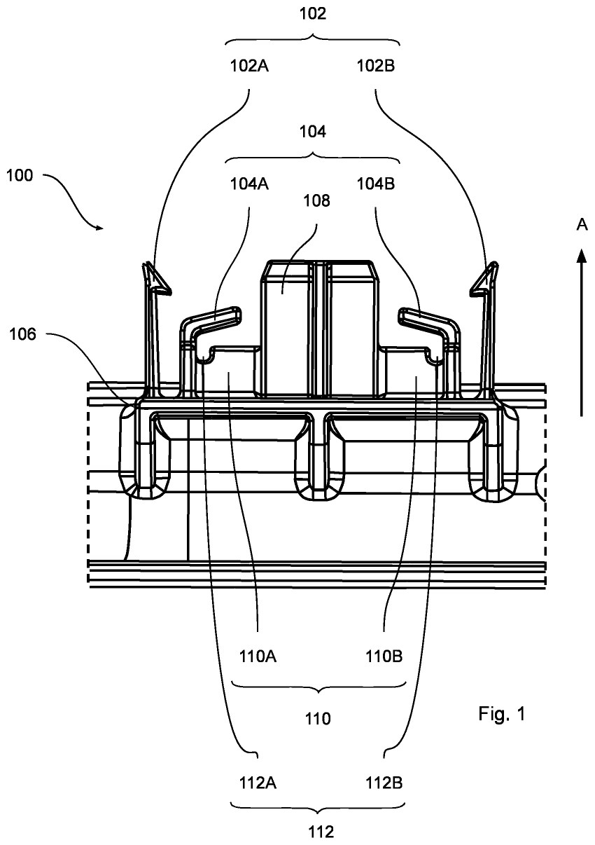

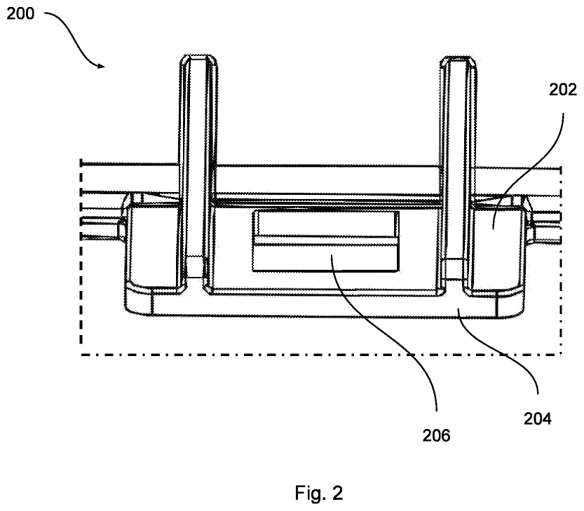

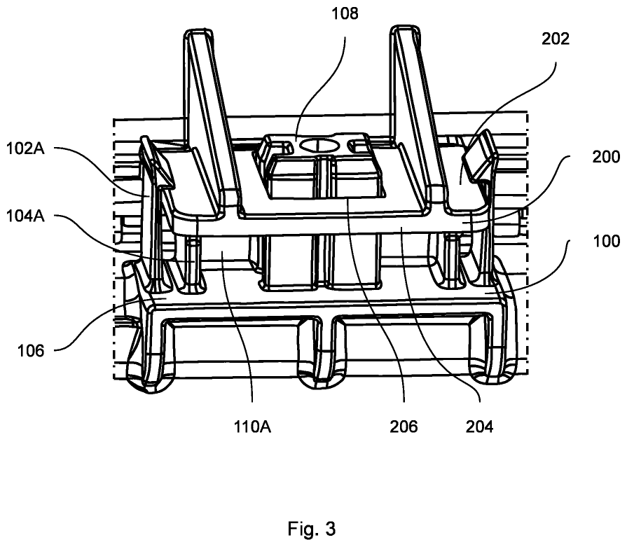

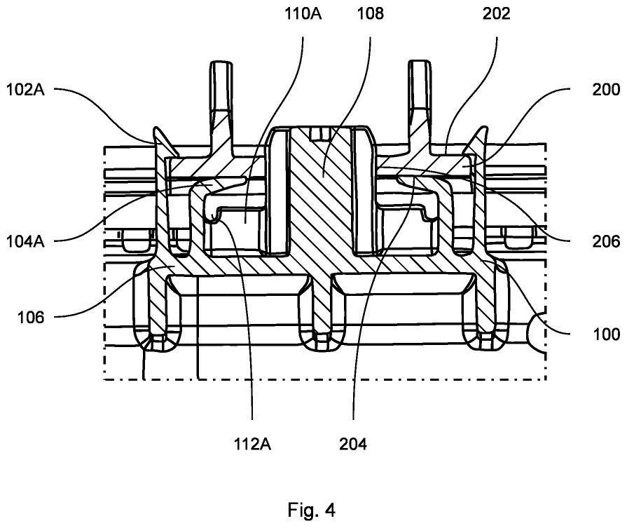

FIG. 1 illustrates a clip fastener 100, in accordance with an embodiment of the present invention. FIG. 2 illustrates a counter clip fastener 200 adapted to connect to the clip fastener 100 of FIG. 1. FIG. 3 illustrates an assembly of the clip fastener 100 of FIG. 1 and the counter clip fastener of FIG. 2. FIG. 4 illustrates a sectional view of the assembly of the clip fastener 100 and the counter clip fastener 200 of FIG. 3. The clip fastener 100 comprises at least one first member 102 and at least one second member 104 extending from the base portion 106; a support member 108 extending from the base portion 106; and at least one connection portion 110 extending from the base portion 106, at one end, is connected to the support member 108 and at another end, is connected to the at least one second member 104, wherein a cut 112 is provided in the at least one connection portion 110. The clip fastener 100 is adapted to engage and connect with the counter clip fastener 200, wherein the counter clip fastener 200 is hatched in FIG. 4.

In one embodiment, the clip fastener 100 can comprise a first member 102 and a second member 104 extending from the base portion 106. The clip fastener 100 can comprise the support member 108 extending from the base portion 106, wherein the second member 104 is located between the first member 102 and the support member 108. The clip fastener 100 can comprise a connection portion 110 extending from the base portion 106, wherein the connection portion 110, at one end, is connected to the support member 108 and at another end, is connected to the second member 104. The connection portion 110 further can comprise the cut 112.

In one aspect, the first member 102 together with the second member 104 can be adapted to engage with and retain the counter clip fastener 200. The first member 102 and the second member 104 can be resilient members that come back to their original positions when displaced from their original positions. In one example, the first member 102 can be configured to retain the counter clip fastener 200. The first member 102 can comprise a projection that abuts the counter clip fastener 200 at a first portion 202 of the counter clip fastener 200 and prevents the counter clip fastener 200 from moving away from the clip fastener 100. The projection can have a triangular shape and is preferably located at top of the first member 102, wherein the top of the first member 102 is a free end of the first member 102. In another example, the second member 104 can be configured to push the counter clip fastener 200 away from the clip fastener 100. The second member 104 can comprise a bent portion that abuts the counter clip fastener 200 at a second portion 204 of the counter clip fastener 200 and pushes the counter clip fastener 200 away from the clip fastener 100. The bent portion can be inclined with respect to the base portion 106 and is preferably located at top of the second member 104, wherein the top of the second member 102 is a free end of the second member 104. In another example, the first portion 202 and the second portion 204 of the counter clip fastener 200 can be two opposite sides of the counter clip fastener 200. In another example, height of the first member 102 from the base portion 106 can be higher than that of the second member 104, wherein heights of the first member 102 and the second member 104 are measured in a direction A in which the first member 102 and the second member 104 extend from the base portion 106.

In another aspect, the support member 108 can be adapted to support the counter clip fastener 200. The support member 108 can be a rigid member that does not displace from its original position. In another example, the support member 108 can be configured to guide the counter clip fastener 200 when the counter clip fastener 200 connects with the clip fastener 100. The support member 108 can pass through an opening 206 provided in the counter clip fastener 200, thereby guide the counter clip fastener 200 when the counter clip fastener 200 connects with the clip fastener 100. In another example, the support member 108 can be configured to aid the first member 102 to retain the counter clip fastener 200. The support member 108 can have a retainer portion that abuts and retains the counter clip fastener 200. In another example, height of the support member 108 from the base portion 106 can be equal to or higher than that of the first member 102 and higher than that of the second member 104, wherein heights of the first member 102, the second member 104 and the support member 108 are measured in the direction A in which the first member 102, the second member 104 and the support member 108 extend from the base portion 106.

In another aspect, height of the connection portion 110 from the base portion 106 can be lower than that of the first member 102, the second member 104 and the support member 108, wherein heights of the first member 102, the second member 104, the support member 108 and the connection portion 110 are measured in the direction A in which the first member 102, the second member 104, the support member 108 and the connection portion 110 extend from the base portion 106. In another aspect, the cut 112 can be located adjacent to the second member 104, in the connection portion 110. In another example, the cut 112 can be located at top of the connection portion 110, wherein the top of the connection portion 110 is an end of the connection portion 110 away from the base portion 106. The cut 112 can be located at a junction where the second member 104 joins the connection portion 110. In another example, the cut 112 can have any shape, such as but not limited to curved shape, square shape or rectangle shape.

In another embodiment, the clip fastener 100 can comprise two first members 102A, 102B and two second members 104A, 104B extending from the base portion 106. In another example, the two second members 104A, 104B can be located between the two first members 102A, 102B. The clip fastener 100 can comprise the support member 108 extending from the base portion 106. In another example, the support member 108 can be located between the two second members 104A, 104B. The clip fastener can comprise two connection portions 110A, 110B extending from the base portion 106, wherein the two connection portions 110A, 110B, at one end, are connected to the support member 108 and at another end, are connected to the two second members 104A, 104B respectively. The two connection portions 110A, 110B further can comprise two cuts 112A, 112B respectively. In another example, the two cuts 112A, 112B can be located adjacent to the two second members 104A, 104B respectively.

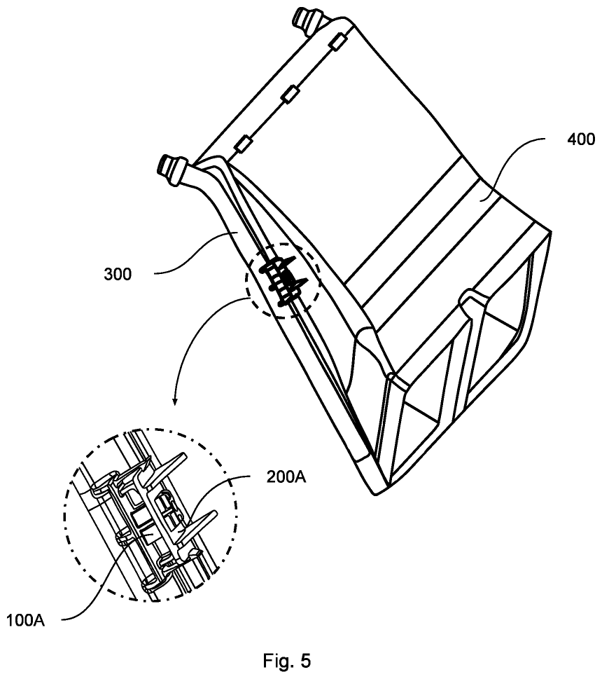

FIG. 5 illustrates an assembly of a first part 300 comprising the clip fastener 100 of FIG. 1 and a second part 400 comprising the counter clip fastener 200 of FIG. 2, in accordance with another embodiment of the present invention. The first part 300 can comprise at least one clip fastener 100 adapted to connect the first part 300 to a second part 400. The second part 400 can comprise at least one counter clip fastener 200 adapted to engage and connect with the at least one clip fastener 100. In another aspect, the first part 300 and the second part 400 can be any part, such as but not limited to a heat exchanger, air duct, stone guard or fan unit. In another example, the first part 300 can be a heat exchanger and the second part 400 can be an air duct adapted to connect to the first part 300. The first part 300 can comprise two clip fasteners 100A, 100B provided in two sides of the first part 300 respectively. The second part 400 can comprise two counter clip fasteners 200A, 200B provided in two sides of the second part 400 respectively. The two clip fasteners 100A, 100B of the first part 300 engage and connect with the two counter clip fasteners 200A, 200B of the second part 400 respectively.

In another example, the first part 300 can be a heat exchanger and the second part 400 can be a stone guard adapted to connect to the first part 300. In another example, the first part 300 can be a heat exchanger and the second part 400 can be a fan unit adapted to connect to the first part 300. In another example, the first part 300 can be a heat exchanger and the second part 400 can be another heat exchanger adapted to connect to the first part 300. The clip fastener 200 described in the above embodiments can be adapted to connect any two parts together and should not be limited to heat exchanger alone.

According to the above-described embodiments, the clip fastener 100 comprises the two cuts 112A, 112B adjacent to the two second members 104A, 104B respectively, in the two connection portions 110A, 110B respectively. Therefore, stress in the clip fastener 100 is reduced when the clip fastener 100 is connected with the counter clip fastener 200. Since the stress in the clip fastener 100 is reduced, failure of the clip fastener 100 is prevented when the clip fastener 100 is connected with the counter clip fastener 200.

All the above-described embodiments are just to explain the present invention while more embodiments and combinations thereof might exist. Hence, the present invention should not be limited to the above-described embodiments alone.

1. A clip fastener for cooperating with a counter clip fastener, comprising:
a base portion,
a pair of first members extending from the base portion,
a pair of second members extending from the base portion,
a support member extending from the base portion,
a pair of connection portions extending from the base portion,
wherein the pair of the second members is located between the pair of the first members,
wherein the support member is located between the pair of the second members,
wherein one of the pair of the connection portions is located between and connected with the support member and one of the pair of the second members, while the other one of the pair of the connection portions is located between and connected with the support member and the other one of the pair of the second members,
wherein each of the pair of the connection portions includes a cut located adjacent to a respective one of the pair of the second members.

2. The clip fastener according to claim 1, wherein the pair of the first members together with the pair of the second members are adapted to engage with and retain the counter clip fastener.

3. The clip fastener according to claim 1, wherein the support member is adapted to support the counter clip fastener.

4. The clip fastener as claimed in claim 1, wherein the support member is configured to guide the counter clip fastener with respect to the clip fastener.

5. The clip fastener as claimed in claim 1, wherein the pair of the second members is configured to exert force pushing the counter clip fastener away from the clip fastener when assembled together.

6. The clip fastener as claimed in claim 5, wherein each one of the pair of the second members is configured to elastically bend towards the base portion by the counter clip fastener when assembled together.

7. The clip fastener as claimed in claim 1, wherein the pair of the first members is configured to prevent the counter clip fastener from moving away from the clip fastener when assembled together.

8. The clip fastener as claimed in claim 7, wherein each one of the first members is configured to elastically bend with respect to the pair of the second members, wherein each one of the first members prevents the counter clip fastener from moving away from the clip fastener in a first, unbent position and allows the counter clip fastener to move away from the clip fastener in a second, bent position.

9. The clip fastener as claimed in claim 1, wherein the pair of the two first members protrudes from the base portion further than the pair of the two second members.

10. The clip fastener as claimed in claim 1, wherein each cut is located at a side of the connection portions that are facing away from the base portion.

11. An assembly comprising:
a first part including
a clip fastener for cooperating with a counter clip fastener, including:
a base portion,
a pair of first members extending from the base portion,
a pair of second members extending from the base portion,
a support member extending from the base portion,
a pair of connection portions extending from the base portion,
wherein the pair of the second members is located between the pair of the first members,
wherein the support member is located between the pair of the second members,
wherein one of the pair of the connection portions is located between and connected with the support member and one of the pair of the second members, while the other one of the pair of the connection portions is located between and connected with the support member and the other one of the pair of the second members,
wherein each of the pair of the connection portions includes a cut located adjacent to a respective one of the pair of the second members; and a second part including the counter clip fastener with a first portion adapted to engage with the pair of the two first members of the clip fastener.

12. The assembly as claimed in claim 11, wherein the counter clip fastener includes a second portion adapted to engage with the pair of the two second members of the clip fastener.

13. The assembly as claimed in claim 11, wherein the counter clip fastener includes an opening adapted to engage with the support member of the clip fastener.

14. The assembly as claimed in claim 11, wherein each one of the pair of the second members is configured to elastically bend towards the base portion, wherein the counter clip fastener includes a second portion adapted to engage with the pair of the two second members so that when the clip fastener and the counter clip fastener are assembled together, the second portion elastically bends each one of the pair of the second members towards the base portion.

15. The clip fastener as claimed in claim 11, wherein each cut is located at a side of the connection portions which are facing away from the base portion.

16. The assembly as claimed in claim 14, wherein each one of the pair of the second members bends towards the base portion within the respective cut of each of the pair of the connection portions.

17. The assembly as claimed in claim 11, wherein the first part is a heat exchanger.

18. The assembly as claimed in claim 17, wherein the second part is any one of an air duct, a stone guard, a fan unit or another heat exchanger.
